(19) United States
(12) Patent Application Publication
(10) Pub. No.: US 2019/0314248 A1
(43) Pub. Date: Oct. 17, 2019

(54) HANDS-FREE BOTTLE HOLDER

(71) Applicants: Yana F. Krefman, West Bloomfield, MI (US); Cory M. Ostrow, Southfield, MI (US)

(72) Inventors: Yana F. Krefman, West Bloomfield, MI (US); Cory M. Ostrow, Southfield, MI (US)

(21) Appl. No.: 16/386,865

(22) Filed: Apr. 17, 2019

Related U.S. Application Data
(60) Provisional application No. 62/658,795, filed on Apr. 17, 2018.

(51) Int. Cl. A61J 9/06

(52) U.S. Cl. CPC A61J 9/063; A47G 23/0216; A61J 9/0623

(57) ABSTRACT

A hands-free bottle holder has a pair of opposed, integrally formed, interconnected, substantially trapezoidal wedge members. When assembled, each wedge member is the mirror image of the other. Blocks associated with the wedges enable height adjustment. A hinge rotatably interconnects the two wedge members. A seam formed medially of the wedges defines a hinge. A bottle holder is seated atop an upper surface of one of the wedge members.

### CROSS REFERENCE TO RELATED APPLICATION

This application is a completion application of co-pending U.S. Provisional Patent Application Ser. No. 62/658,795, filed Apr. 17, 2018, for “Hands-Free Bottle Holder”, the entire disclosure of which is hereby incorporated by reference, including the drawing.

### BACKGROUND OF THE INVENTION

### 1. Field of the Invention

The present invention pertains to beverage containers. More particularly, the present invention pertains to a “hands-free” beverage container. Even more particularly, the present invention pertains to a height adjustable hands-free beverage container.

### 2. Description of the Prior Art

As is known to those skilled in the art to which the present invention pertains, bottle feeding of babies, can be quite cumbersome. Under ordinary circumstances, the baby has to be held, or otherwise restrained and the nipple of the bottle placed into its mouth. The need to hold the baby is directly related to the baby's inability to hold the bottle on its own. This can be a time-consuming chore, which precludes the person feeding the baby from doing other tasks or chores, or attending to other children, while still attending to the baby's needs.

The art has appreciated this and has devised certain “hands-free” baby bottle holding devices. For example, in U.S. Pat. No. 6,098,934, there is disclosed a wedge-shaped baby bottle support, which enables the baby bottle to be secured to one side of the surface of the wedge and which extends toward the baby's mouth. The device further includes a strap or other securement for attaching the wedge to a baby carrier. However, it is to be appreciated that the device contains the bottle at a single incline elevation. Further, the bottle is held in position through an elongated strap which is secured to the surface and comprises an elastic member and, therefore, does not have the ability to accommodate, in a secured manner, different sized bottles or other containers.

In U.S. Pat. No. 4,733,836, there is disclosed a nursing bottle holder which enables an infant to be placed on its side while nursing. Additionally, U.S. Pat. No. 3,999,731 discloses an adjustable holder for a nursing bottle which has a base assembly and a supporting structure on the base which only allows vertical adjustability of the base, itself.

Additionally, U.S. Pat. No. 8,118,268 shows a baby bottle holder and feeder which is removably mounted onto a substantially u-shaped pillow. However, in order for the infant to feed itself in a hands-free manner requires the infant to turn its head toward the bottle.

In U.S. Pat. No. 6,523,793 there is disclosed an arch which overlies an infant and which maintains an incline a baby bottle. The arch is part of a system of cushions which are supported on a mat.

It is to be appreciated that, while each of these devices exhibit usefulness for the intended purposes, it is clear that these devices hold the bottle at a fixed elevation or incline. Thus, there is no ability to adjust the height of the bottle when brought into proximity to the mouth of the infant or baby. It is to this which the present invention is directed.

### BRIEF DESCRIPTION OF THE DRAWINGS

FIG. 1 is a perspective of a hands-free beverage holder in accordance with the present invention;

FIG. 2 is an exploded perspective view of the holder hereof;

FIG. 3 is a side view, partly in phantom, showing the rotatability of the present holder;

FIG. 4 is a front view of the holder hereof;

FIG. 5 is a top plan view hereof;

FIG. 6 is a perspective view of an alternate embodiment hereof;

FIG. 7 is a perspective view of an alternate embodiment of a wedge used in accordance herewith, showing the block in a height adjustment position;

FIG. 8 is a perspective view similar to that of FIG. 7, but showing the wedge in a partial rotation position; and

FIG. 9 is a further perspective view, partly in phantom, showing the block in a stowed position.

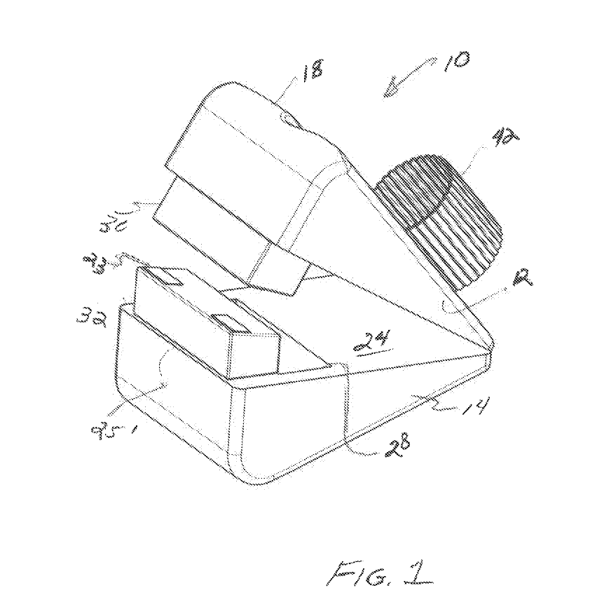

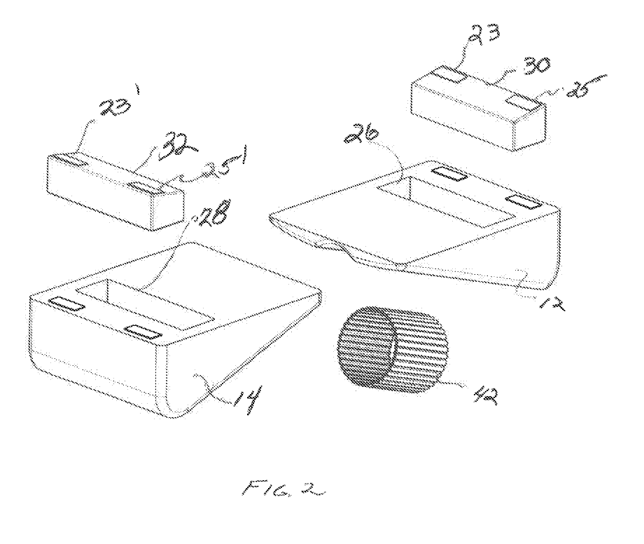

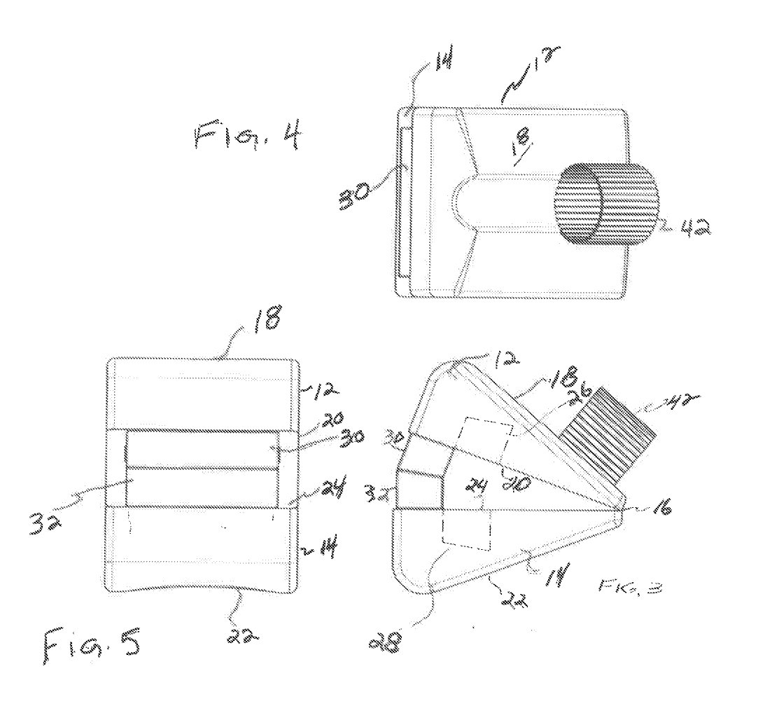

### DESCRIPTION OF THE INVENTION

Now, and in accordance with the present invention and with reference to the drawing, there is depicted an adjustable, hands-free, beverage container holding device. Although the ensuing description is to be made with reference to a baby bottle, it is to be understood that the present invention may have applicability to other geometrically configured beverage containers.

Now, with reference to the drawing, there is depicted therein, a hands-free bottle holder in accordance herewith and, generally, denoted at 10. The holder 10 comprises a pair of opposed, integrally formed, interconnected, substantially trapezoidal wedge members 12, 14, respectively. When assembled, each wedge member is the mirror image of the other.

A hinge 16 rotatably interconnects the two wedge members 12, 14. Preferably, the hinge is the seam formed medially of the wedges during the manufacturing process.

For purposes of explanation, it is to be appreciated that the wedge 12 is denoted as the upper wedge and the wedge 14 is the bottom wedge.

The wedge 12 has an upper outer surface 18 and a lower interior surface 20.

The wedge 14 has a lower outer surface 22 and an interior surface 24.

As shown, the inner surfaces 20 and 24 are in opposition.

As shown, each of the opposed surfaces has and includes a cut-out or recess 26, 28, respectively. Each recess removably stores a block 30, 32. The blocks 32 provide for height adjustment. Each of the blocks are similar in construction and are configured to removably nest within an associated recess 28 or 30 and to independently removably mount to respective opposed inner surfaces 20 and 24.

It is to be readily perceived that when both blocks are removed from their respective recesses and the wedges are brought into mating relationship, the holder is at one height. When a single block 32 or 34 is inserted into a respective recess and the wedges are brought into opposition with each other, the holder is at a second height. When the blocks are each nested in their respective recesses and the wedges are urged toward each other, the holder is at a third height, thereby rendering the holder adjustable in height to accommodate the height of the user, etc.

Each block includes means, such as at least one hook and loop fastener, such as at 23, 25 shown on block 30 and 23′, 25′ on block 32. The fasteners hold the blocks in position with regard to each other and with respect to its associated wedge. Similar hook and loop fasteners can be provided on the bottom of each block as well as in the bottom of each recess to hold the associated wedge in position.

A bottle retainer 40, such as an elastic ring 42, such as that sold commercially under the name “Velcro” is secured to the upper surface 14 of the wedge member 12. The ring 42 is secured to the upper surface 14 by any suitable means such as sonic welding, sewing, gluing, or the like.

The top surface includes a recess 53 for removably seating a container such as a baby bottle therein.

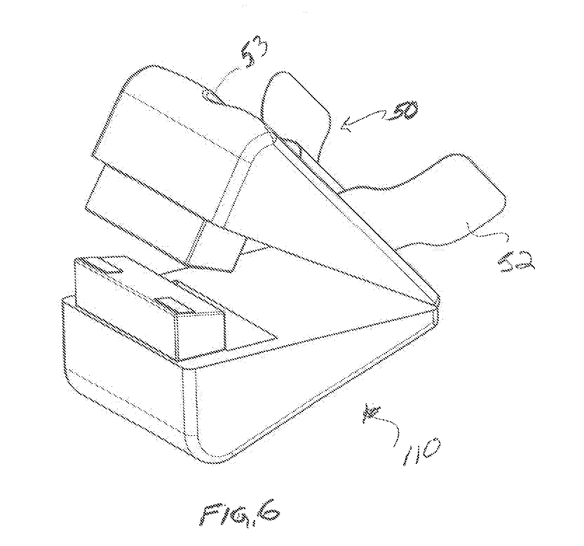

Alternatively, and as shown in FIG. 6, in a second embodiment hereof a holder 110 includes an adjustable strap 50 deployed in lieu of the ring 42. The strap 50, generally, comprises a strip 52 of sufficient width and length to encircle a bottle or other container. The strap 50 is secured to the upper surface 14 medially thereof by suitable means, such as sewing, sonic welding, gluing or the like.

Preferably the strip 52 comprises a hook and loop strip such as that sold commercially under the mark “Velcro.” The strap 50 is dimensioned to removably hold bottles of various sizes. In all other respects, the holder 110 is constructed in the same manner as the holder 10.

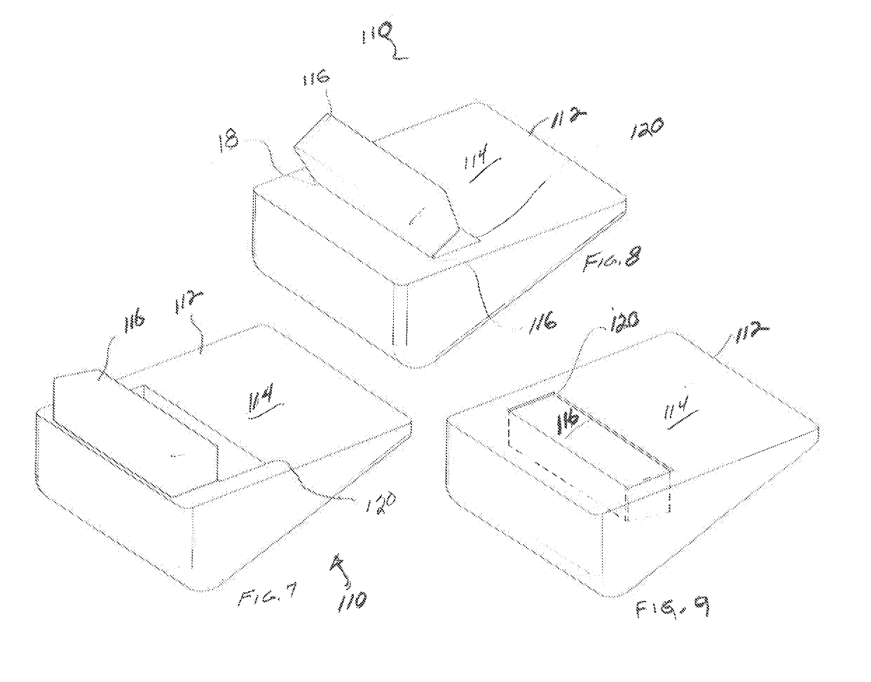

Referring now to FIGS. 7-9, there is depicted therein an alternate embodiment hereof, generally, denoted at 210. Although the following description is made with reference to a wedge 212, it is to be understood that there is an opposing wedge which is substantially the mirror image of the wedge 212. As shown, the wedge 212 has an interior surface 214 in which is stowable a block 216. According to this embodiment, the block 216 is integrally formed with the wedge 212 and includes an integrally formed hinge 218.

A recess or niche 220 is formed in the surface 214. The recess 214 is dimensioned to rotatably nest or stow the block 216. Thus, the block can be rotated from its nested position to a height adjustment position as shown herein. The block 216 is rotatable between about 0° to about 90° about the hinge 218.

As shown, the hinge 218 is formed at the edge of the recess or niche 120 closest to the free end 230 of the edge.

It is to be appreciated that according to this embodiment, the need for separate means for holding the blocks in position, such as the hook and loop fasteners described above, is eliminated.

In all other respects, the holder is similar to that of the first embodiment, except that the strap of the embodiment of FIG. 6 may be used in lieu of the ring.

Preferably, the present holder is manufactured from a suitable, closed cell foam, such as a polyurethane, silicone rubber, polyurea rubber, ethylene-vinyl acetate foam, or similar type materials. By using a closed cell foam, there is provided a moisture barrier so that any liquid spillage is substantially precluded from seeping into the wedges and/or blocks. Typically, these foams are injection molded or blow molded to prepare the product. Some molding techniques are well known to the skilled artisan.

Although not preferred, an open cell foam may be used.

Optionally, a non-porous cover (not shown) may be used to enshroud at least the exterior of the holder to further enable any spillage of liquid to be readily cleaned up and the holder can maintain its integrity and be maintained in a sterile condition.

It should further be noted that in manufacturing the present holder, the bottom wedge has a slightly larger length than the top wedge to facilitate, not only gripping, but rotation of the wedges, as well.

It is to be appreciated from the preceding that there has been described herein a hands-free beverage holder which can be adjusted in height and which can readily accommodate an infant or other person to be placed in proximity to the bottle without the need for an attendant holding the bottle.

Having, thus, described the invention, what is claimed is:

1. An adjustable hands-free beverage container holder, comprising:
(a) an upper wedge member having an upper outer surface and a lower interior surface, the lower surface;
(b) a bottom wedge member having an interior surface and a lower outer surface, the second wedge member;
(c) a hinge rotatably interconnecting the first and second wedge members;
(d) a height adjustment block nested in at least one associated recess;
(e) a beverage container retainer secured to the upper outer surface of the upper wedge; and
(f) wherein at least one of the wedge members having a recess formed therein.
